(19) United States
(12) Patent Application Publication
(10) Pub. No.: US 2006/0260363 A1
(43) Pub. Date: Nov. 23, 2006

(54) Method of manufacturing optical element

(76) Inventors: Kazunari Tada, Osaka (JP); Kazuyuki Ogura, Osaka (JP); Yoshihiro Kamada, Osaka (JP); Kojiro Takatori, Tokyo (JP); Takashi Sannokyou, Tokyo (JP)

Correspondence Address: BRINKS HOFER GILSON & LIONE, P.O. BOX 10395, CHICAGO, IL, 60610, US

(21) Appl. No.: 11/406,820

(22) Filed: Apr. 19, 2006

(30) Foreign Application Priority Data
Apr. 20, 2005 (JP) 2005-122053

(51) Int. Cl. C03B 37/023

(52) U.S. Cl. 65/385

(57) ABSTRACT

The present invention provides a method of efficiently mass-producing square-shaped optical elements having high decentering accuracy. For this reason, a molded article where a plurality of optical elements are arranged is manufactured by one-time molding by using one set of molds. The molded article obtained in such a manner is cut into individual optical elements.

The present application claims priority to Japanese Patent Application Laid-Open No. 2005-122053 filed in Apr. 20, 2005, the entire content of which is hereby incorporated by reference.

### BACKGROUND OF THE INVENTION

1. Field of the Invention

The present invention relates to a method of manufacturing an optical element. Particularly, the invention relates to the method of manufacturing a beam shaping element for converting oval output light such as blue laser diode (LD) into circular light.

2. Description of the Related Art

In general, light sources to be used in pickup optical systems are LDs, and their emitted beams are oval divergent beams. When such a divergent beam is directly focused by an objective lens, the beam exposes only a part of a circular recording region or also the outside of the recording region, thereby deteriorating the accuracy of recording and reproduction. It is, therefore, necessary to shape a beam in order to make a section on a recording medium circular.

Particularly in recent years, blue semiconductor lasers are used as light sources, but since a wavelength becomes shorter, the accuracy required for signals of recording and reproduction becomes strict. At present, however, outputs from the blue lasers are weak, and thus sufficient laser powers cannot be secured for accurate recording and reproduction. In order to solve this problem, it is necessary to shape an oval section of the beam from LD into a circular beam section so as to heighten the utilization efficiency of the laser, and thus the beam shaping technique for this is very important.

The beam shaping is performed normally by a beam shaping element. As a result, a divergent beam can be shaped directly, and a beam with an approximately circular section can be generated with hardly generating aberration. As such elements, a beam shaping element with both cylindrical surfaces (Japanese Patent Application Laid-Open No. 2002-208159), or a beam shaping element whose one surface is a cylindrical surface and the other surface is an anamorphic surface is proposed.

Such beam shaping elements require high decentering accuracy between generatrices of respective cylindrical surfaces (parallel decentering: about 1 to 10 μm, tilt decentering: about 1 to 10 min.).

The above beam shaping elements require the definite alignment work at the time of incorporating pickups, and thus the adjustment method becomes very complicated (parallel decentering: about 1 to 10 μm, tilt decentering: 1 to 5 min.).

A beam shaping element is generally disposed near LD, and a beam with small beam diameter faces the element. Since, therefore, an energy with very high density is applied to the element, a plastic lens cannot be used, it is indispensable to produce a glass lens. In general, however, a glass lens is formed by a reheat method, and thus its cycle time becomes up to 20 minutes, which is inefficient. For this reason, the glass lenses are not adequate to mass production. Since the shaping element requires incorporating alignment in a rotating direction of the element due to its specific shape, a square-shaped shaping element is desired, but it is currently difficult to mold an element into a square outer shape.

### SUMMARY OF THE INVENTION

It is a main object of the present invention to provide a method of manufacturing an optical element having high decentering accuracy.

It is another object of the present invention to provide a method of mass-producing optical elements with high accuracy efficiently.

In order to attain these objects and another object, from a certain aspect of the present invention, a method of manufacturing an optical element having a squire outer shape, includes the following steps:

manufacturing a molded product where a plurality of optical elements are arranged with one-time molding using one set of molds for forming respective surfaces; and

cutting the molded article into individual optical elements.

The invention itself, together with further objects and attendant advantages, will best be understood by reference to the following detailed description taken in conjunction with the accompanying drawings.

### BRIEF DESCRIPTION OF THE DRAWINGS

FIG. 1 is a schematic sectional view of upper and lower molds;

FIG. 2 is a schematic perspective view of a beam shaping element;

FIG. 3A is a schematic perspective view of a mold (for one piece), and FIG. 3B is a schematic perspective view of a mold (for one piece);

FIG. 4A is a schematic perspective view of a mold (for three pieces), and FIG. 4B is a schematic perspective view of a beam shaping element molded article (for three pieces: before cutting);

FIG. 5 is a diagram for explaining a method of molding a glass material;

FIG. 6 is a schematic perspective view of a beam shaping element molded article (a plurality of pieces: before cutting);

FIG. 7 is a schematic perspective view of a beam shaping element molded article (three pieces: before cutting);

FIG. 8 is a schematic perspective view of a beam shaping element molded article (nine pieces: before cutting);

FIG. 9A is a schematic perspective view of a beam shaping element molded article with marker, and FIG. 9B is a schematic perspective view of a beam shaping element molded article with marker; and

FIG. 10A is a diagram for explaining a method of pressing a side surface member, and FIG. 10B is a schematic perspective view of a surrounding member.

In the following description, like parts are designated by like reference numbers throughout the several drawings.

### DETAILED DESCRIPTION OF THE PREFERRED EMBODIMENT

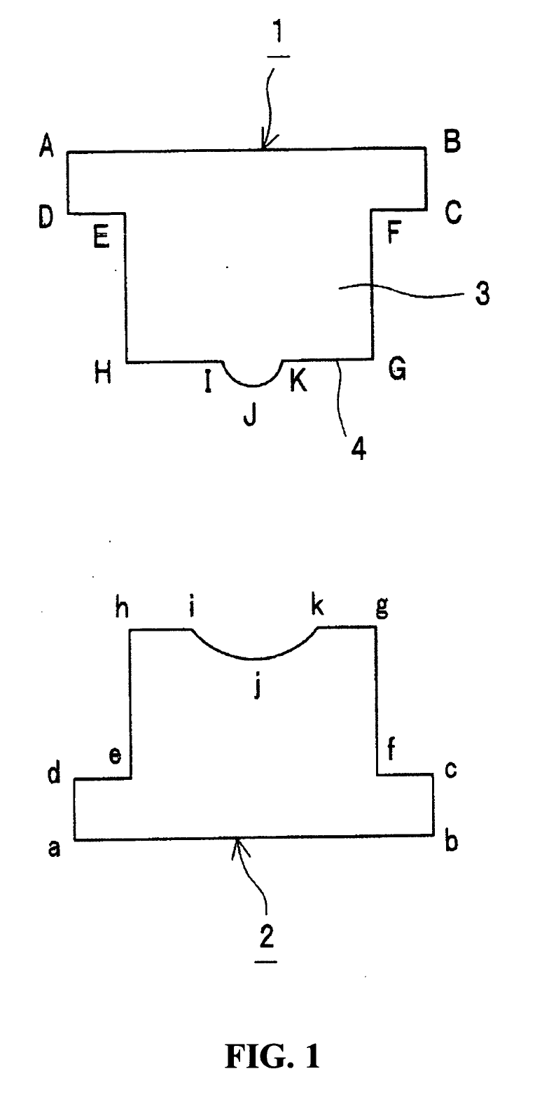

FIG. 1 illustrates one example of a schematic sectional view of one set of upper and lower molds to be used when a beam shaping element having both cylindrical surfaces are manufactured.

The upper mold is constituted so that a molding surface (HIJKG) 4 is formed on a mold base material 3. A section of the mold base material 3 is composed of a rectangle ABCD, a rectangle EFGH having a side EF whose length is not more than a length of a side CD, and a cylindrical section IJK formed on a side HG. The cylindrical section IJK has a convex shape in FIG. 1, and includes an arc surface or a non-arc surface. The cylindrical section IJK is preferably positioned on the center of the molding surface 4, but it is not limited to this form as long as the molding surface is formed so as to satisfy the following “specified value”. A surface in a generatrix direction including the side HG having the cylindrical section IJK is a cylindrical surface of the upper mold.

In the present invention, a direction which is vertical to a sheet surface of FIG. 1 on which the section of the molds is described is defined as the “generatrix direction”, and a direction which is vertical to the generatrix, for example, a direction parallel with a side AB is defined as a “directrix direction”. In the present invention, “parallel” and “vertical” are respectively used as concepts represented by “approximately parallel” and “approximately vertical”. “Approximately” in this specification means 60 minutes (1°) or less.

In the present invention, a side surface (plane) of the mold in the generatrix direction including the side EH or FG, particularly the side surface of the mold including the side EH is defined as an “upper mold reference surface 1”. The reference surface 1 is mainly explained below, but needless to say, the following description may be applied to the side surface of the mold including a side EG as an “upper mold reference surface 2”, or to both the “upper mold reference surface 1” and the “upper mold reference surface 2”.

The upper mold to be used in the present invention has a cylindrical surface which is processed so as to have a line which connects an intersecting point between a non-arc axis and the cylindrical section IJK and an intersecting point between an arc center axis and the cylindrical section IJK (upper mold generatrix”). The “non-arc axis” is defined by an axisymmetric center line with a non-arc shape defined by an aspherical formula and an aspherical coefficient. The “arc center axis” is defined by a vertical bisector of both ends (I and K of FIG. 1) in an arc processing area of the mold.

The lower mold to be used in the present invention is processed so that a distance between the generatrix of the upper mold and the upper mold reference surface 1 obtains a specified value.

The lower mold 2 is constituted so that a molding surface (hijkg) is formed on the mold base material 3. Its section is composed of a rectangle abcd, a rectangle efgh having a side ef whose length is not more than a length of a side cd, and a cylindrical section ijk formed on a side hg. The cylindrical section has a concave shape in FIG. 1, and includes an arc surface or a non-arc surface. A surface in the generatrix direction including the side hg having the cylindrical section ijk is a cylindrical surface of the lower mold.

In the present invention, a mold side surface (plane) in the generatrix direction including a side eh or fg, particularly the cylinder surface including the side eh is defined as a “lower mold reference surface 1”. The reference surface 1 is mainly explained below, but needless to say, the following description may be applied to a mold side surface including the fg as a “lower mold reference surface 2”, or to both the “lower mold reference surface 1” and the “lower mold reference surface 2”.

The lower mold to be used in the present invention has a cylindrical surface which is processed so as to have a line which connects an intersecting point between a non-arc axis and a cylindrical section ijk and an intersecting point between an arc center axis and the cylindrical section ijk (“lower mold generatrix”).

The lower mold to be used in the present invention is processed so that a distance between the lower mold generatrix and the lower mold reference surface 1 obtains a specified value.

The “specified value” in the present invention is such that a difference between the distance between the upper mold generatrix and the upper mold reference surface 1 and the distance between the lower mold generatrix and the lower mold reference surface 1 becomes about half or less of a parallel decentering tolerance (1 to 10 μm) required by the target respective cylindrical surfaces of the beam shaping element in a state that the upper mold reference surface 1 is flush with the lower mold reference surface 1.

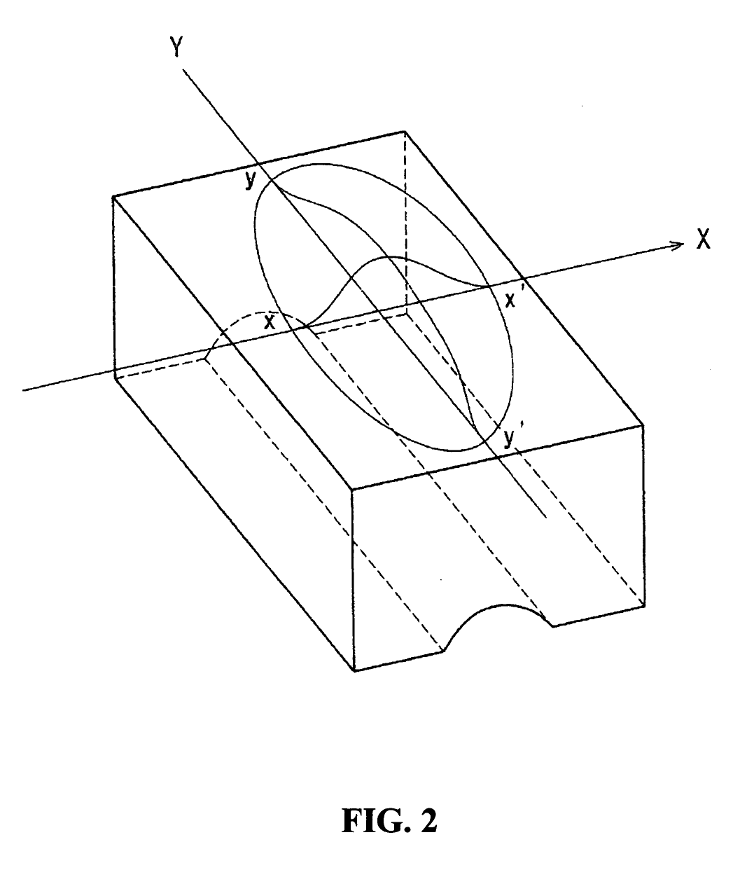

FIG. 2 is a schematic perspective view illustrating the beam shaping element whose one surface is a cylindrical surface and other surface is an anamorphic surface. In the drawing, an X-axial direction corresponds to the directrix in the present invention, and a Y-axial direction corresponds to the generatrix direction in the present invention. The constitution is such that the anamorphic surface having different curvatures and aspherical coefficients in the X and Y axial directions is formed on an XY plane. A long axis yy′ of the anamorphic surface matches with the Y axis and a short axis xx′ of the anamorphic surface matches with the X axis.

In the case where the beam shaping element whose one surface is the anamorphic surface shown in FIG. 2 is manufactured, the surface of the lower mold shown in FIG. 1 has a shape for forming the anamorphic surface of a concave shape. The mold surface fabrication is given so that the long axis of the anamorphic surface matches with the lower mold generatrix.

In the present invention, the base material of both the upper and lower molds is a general material which is normally used for a glass lens molding mold, such as sintered hard alloy, cermet, SiC or stainless subject to Ni plating, particularly, sintered hard alloy. Further, the cylindrical surface and the anamorphic surface are obtained by giving publicly-known desired mirror-like finishing such as grinding process to the molding surface. However, due to gist of the present invention, the present invention includes also constitutions using molds manufactured by using the base materials and methods other than the above-mentioned ones.

Further, at least mold reference surfaces are surfaces which are processed by a general wire process or the like so that their maximum height Ry becomes 0.8 μm or less. Preferably, all the side surfaces are subject to the surface fabrication similar to the reference surfaces.

The upper mold of FIG. 1 has the plane in the generatrix direction including the sides HI and KG, but such a plane is not indispensably necessary. Further, it is not indispensably necessary that the sides HI and KG are parallel with the directrix direction, and they may have positive or negative inclination or may be asymmetric. The lower mold of FIG. 1 has the plane in the generatrix direction including the sides hi and kg, but such a plane is not indispensably necessary. Further, it is not indispensably necessary that the sides hi and kg are parallel with the directrix direction, and thus they may have positive or negative inclination or may be asymmetric.

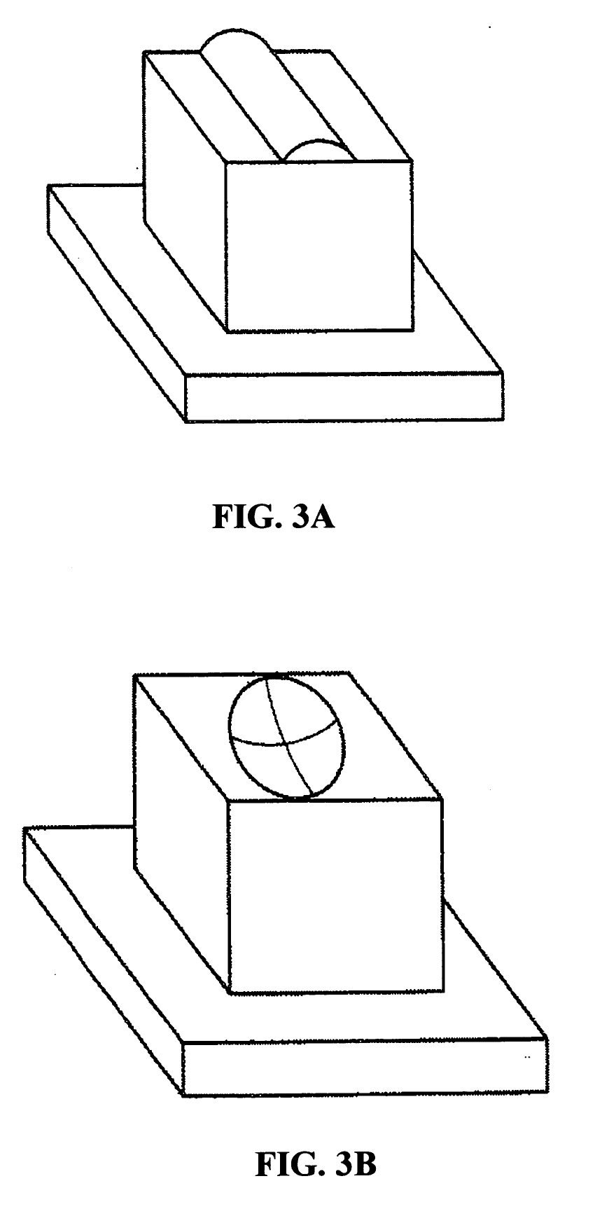

The upper and lower molds have a thickness such that the mold sections are laminated in the generatrix direction. FIG. 3A is a schematic perspective view illustrating the mold for one piece which molds the cylindrical surface of the beam shaping element having the above-mentioned constitution, and FIG. 3B is a schematic perspective view illustrating the mold for one piece which molds the anamorphic surface of the beam shaping element having the above-mentioned constitution.

In order to mass-product the beam shaping elements, a mold, which is constituted so that a plurality of the molds for one piece having the above-mentioned constitution are sequentially connected to each other in the directrix direction or/and the generatrix direction is used as both the upper and lower molds.

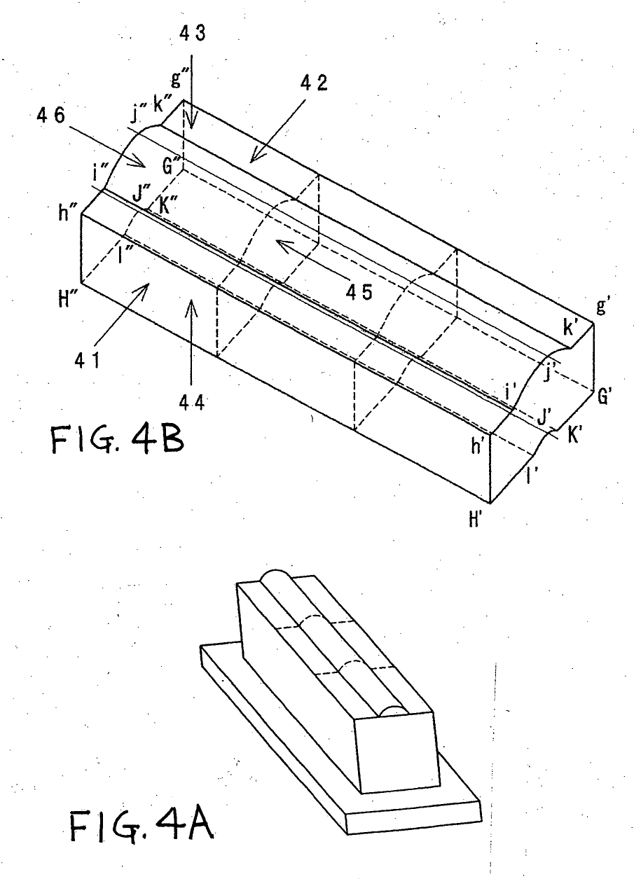

FIG. 4A illustrates one example of the mold in which the above-mentioned three molds for one piece are sequentially formed in the generatrix direction and has the cylindrical surface for enabling three beam shaping elements to be formed at one time (three pieces). FIG. 4B is a schematic perspective view illustrating a beam shaping element molded article (three pieces are obtained) which is obtained by using a pair of the upper and lower molds shown in FIG. 4A. Needless to say, not only the molds for three pieces but also molds for the desired number of pieces may be used.

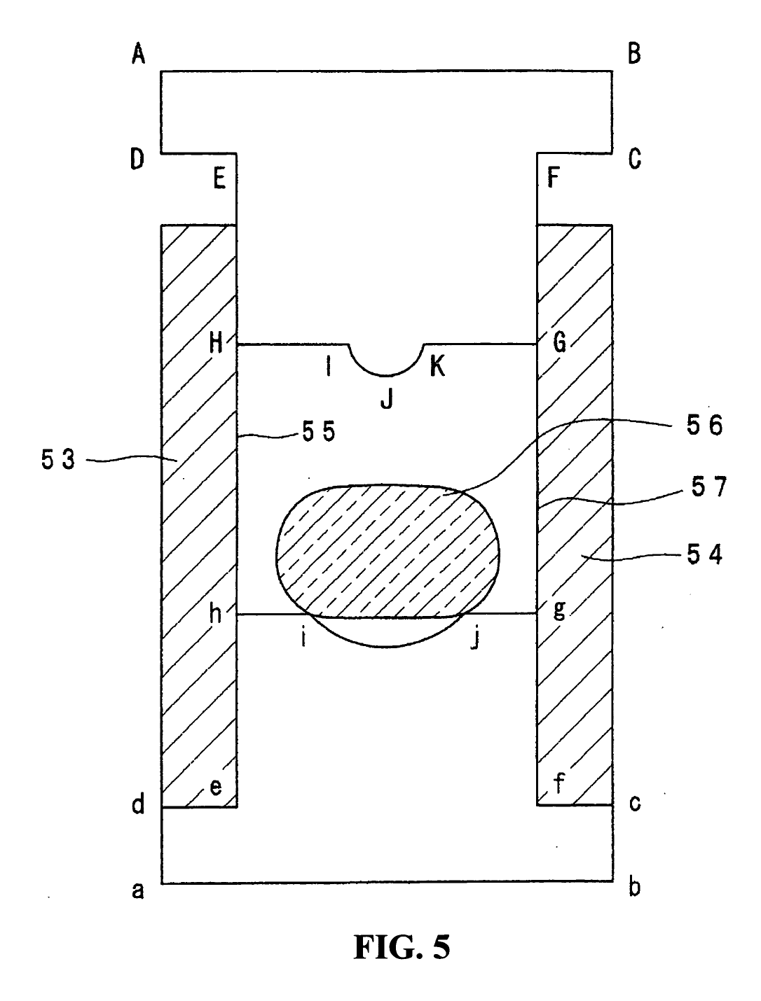

In order to manufacture the beam shaping element whose both surfaces are the cylindrical surfaces using the upper and lower molds, as shown in FIG. 5, a glass material (for example, preform) 56 is arranged between the upper and lower molds, and a side surface forming member (this is called as a “side surface forming member 53”) is pressed against the reference surfaces of the upper and lower molds. Further, a side surface forming member (this is called as a “side surface forming member 54”) is pressed against the side surfaces of the upper and lower molds opposed to the reference surfaces in the directrix direction, and one of the upper and lower molds is moved to a direction where the distance between the upper and the lower molds becomes short, so that a glass material 56 is molded.

The side surface forming member 53 is a plane member, and enables the glass material to be molded in a state that the upper and lower mold reference surfaces 1 are flush with each other. This member 53 is a member for transferring a surface plane 55 of the plane member to the glass material 56. A material, a size, strength and the like of the plane member are not particularly limited as long as fusion does not occur between the member and the glass material 56, deformation does not occur on the surface plane 55 during the molding of the glass material and the above object is achieved. For example, it is preferable that the plane member is a carbide member with thickness of about 1 to 5 mm, and is ground so that the maximum height Ry of a surface plane 25 becomes 0.03 μm or less.

The side surface forming member 54 can be the same as the side surface forming member 53, but the surface plane 57 is not indispensably transferred to the glass material. In this case, the surface plane 57 does not indispensably require the process given to the surface plane 55. Normally, both the side surface members 53 and 54 are pressed from the directriix direction to the mold inside direction so that the surface planes 55 and 57 of the side surface members 53 and 54 are transferred to the glass material.

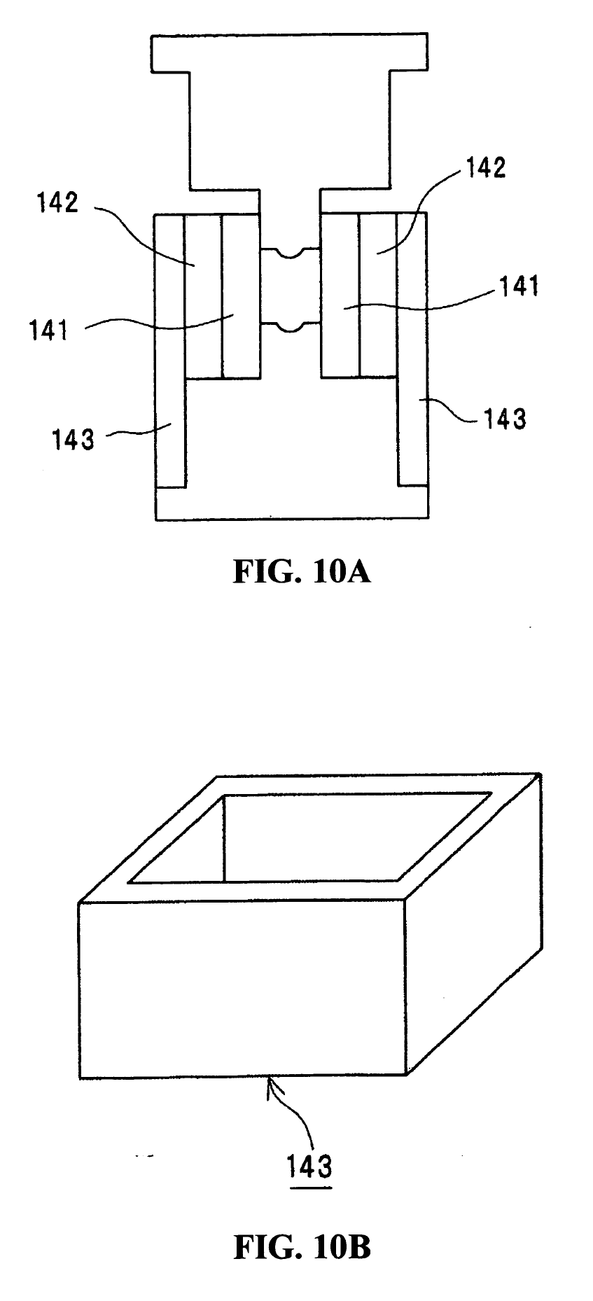

As to the method of pressing the side surface forming members, a pressing unit, a pressing condition and the like are not particularly limited as long as the upper and lower mold reference surfaces 1 are kept to be flush with each other and distortion does not occur on the surface plane 25 during the molding of the glass material. As the pressing unit, for example, an air cylinder can be used. As shown in FIGS. 10A and 10B, side surface forming members 141 and 142, and a surrounding member 143 which contains them are used, the material of the side surface pressing member has a larger linear expansion coefficient than that of the materials of the side surface forming members and the surrounding member. As a result, when the glass material is heated up to a temperature at which glass is softened during the molding press, the side surface pressing member becomes larger than the other members due to heat expansion, so that a state that the upper and lower mold reference surfaces are pressed by the side surface forming members can be obtained easily. Preferably, the material of the side surface forming members is a superhard material, the material of the side surface pressing member is stainless, and the material of the surrounding member is a superhard material.

The above molding method for the glass material is useful when a glass lens is molded by not only the reheat method but also a method of directly pressing a dropped molten glass drop. Examples of the glass material are various glass materials such as crown type lanthanum silica glass, flint type lead silica glass and titanium silica glass.

The side surfaces vertical to the side surface members 53 and 54 (called also as side surface in the generatrix direction”) are not indispensably necessary, and the side surfaces may be suitably set according to the type, size, molding method and the like of the glass material.

When the glass material is pressed from not only the side surface in the directrix direction but also both the side surfaces in the generatrix direction, a pressing pressure is applied to the entire surface of the molded article. For this reason, both the ends in the generatrix direction can have the equivalent surface shape to the center portion. The “equivalent surface shape” means that “the amount of a shift from a design shape of the sectional shape in the directrix direction of the cylindrical surface or the anamorphic surface is equivalent”. When the amount of the shift from the design shape of the sectional shape in the directrix direction in one molded article is uniform, even if a finished article as the beam shaping element is cut out from any portion of one molded article, the beam shaping elements having uniform performance (particularly, transmission wave surface accuracy) can be obtained. When the size of the preform is not accurately adjusted to the specified value (in general, tolerance: ±20 μm), however, variations of the center thickness are generated. The specified value means “specified value of the size of the preform”, and the “specified value of the size of the preform” means a size which is calculated so that a volume of the preform is the same as that of the molded article (for example, in the case where the preform has a rectangular solid shape, the length of three sides). When the glass material (preform) can be supplied by the liquid dropping method or the like, the preforms of different weights can be manufactured comparatively easily by this method. For this reason, this method is suitable as a molding method in which the pressing pressure is applied to the entire surface of the molded article.

In the case where a unit that presses both the side surfaces of the glass material in the generatrix direction is not used, even if the size of the preform cannot be accurately adjusted to the specified value, the center thickness can be adjusted to the specified value (in general, tolerance: ±20 μm) according to the molding condition differently from the case where such a unit is used. In the reheat molding, when the processing cost of the preform provides the great share of the molding cost, this method is advantageous to reduction in cost. Further, when the side surfaces in the generatrix direction are made to be free, stress distortion inside the element can be greatly reduced, thereby preventing a breakage or a crack of the element at the time of the molding.

In the case where the glass material is molded not by the unit for pressing both the side surfaces in the generatrix direction but by the reheat method, since the pressure is not sufficiently applied to both the ends of the molded article in the generatrix direction, the shape of both the ends is not clearer than the shape of the center portion. For this reason, the amount of the shift from the design shape of the sectional shape in the directrix direction of the cylindrical surface or the anamorphic surface becomes larger on both the ends of the molded article in the generatrix direction, and the performance is deteriorated in these areas (particularly, transmission wave surface accuracy). In order to avoid such a problem, when the glass material is molded by the reheat method, it is effective that the thickness of the glass preform in the thickness-wise direction of the beam shaping element is set so that the preform protrudes from the lower mold, more suitably, the thickness is 1.05 or more times as large as the target center thickness of the beam shaping element. For example, in the case where the target center thickness of the element requires 3 mm, the thickness of the preform may be 3.15 mm or more which is 1.05 times as large as 3 mm. When the thickness of the preform is enlarged in such a manner, a molding transfer satisfactory region can be enlarged. When the thickness of the preform is small, the molding transfer satisfactory region becomes small, thereby deteriorating production efficiency. The “molding transfer satisfactory region” means a region which the mold molding transfer surface is satisfactorily transferred to and can be used as an element optical surface. When the molding transfer satisfactory region is small, therefore, the number of the elements obtained at one-time molding decreases.

FIG. 4B is a schematic perspective view illustrating one example of the beam shaping element whose both surfaces are cylindrical surfaces. The beam shaping element is obtained by using the upper and lower molds (for three pieces) shown in FIG. 4A, using the upper and lower mold reference surfaces 1 as reference, and also using the upper and lower mold reference surfaces 2 as a reference similarly to the upper and lower mold reference surfaces 1 and the upper and lower molds (FIG. 1) which are approximately bilaterally-symmetric with each other.

The respective beam shaping elements are obtained by cutting the molded article of FIG. 4B into three in the directrix direction. The side surfaces of the finished beam shaping elements in the directrix direction are transfer surfaces, and the side surfaces in the generatrix direction are cut surfaces. The cut surfaces may be further subject to a process. The addition process is effective for the case where a lot of chips or cracks inevitably occur on a ridge line of the side surfaces of the molded article in the directrix direction under the molding condition where the beam shaping elements with satisfactory performance can be obtained.

A plane H′h′h″H″ (41) is a plane onto which the surface plane 55 of the side surface forming member 53 is transferred (plane B) (also called as “side surface in the directrix direction 41”). A plane G′g′g″G″ (42) (called also as “side surface in the directrix direction 42) is a plane onto which the surface plane 57 of the side surface forming member 54 is transferred (plane C). A plane h′j′k′g′g″k″j″i″h″ (43) is a plane onto which the molding surface of the lower mold is transferred, and a plane H′I′J′K′G′G″K″J″I″H″ (44) is a plane onto which the molding surface of the upper mold 1 is transferred. A plane H′I′J′K′G′g′k′j′i′h′ (45) and a plane H″I″J″K″G″g″k″j″i″h″ (46) are planes which are ground or cut into the planes vertical to the plane B. The surfaces 45 and 46 are not indispensably vertical to the plane B.

When a side surface regulating member is pressed, the molds are moved and the glass material is molded according the above-mentioned specified manner, the upper and lower molds can move only along the plane 55 formed by the side surface regulating member 53. For this reason, in the above element, the non-arc axes of the cylindrical surfaces (or arc center axes) can be provided to specified positions, namely, the parallel decentering of each plane can fall within a tolerance (10 μm or less, preferably a value close to 0), and the tilt decentering of each plane can fall within a tolerance (10 min. or less, preferably a value close to 0).

The “parallel decentering of each plane” means the amount of a shift in the directrix direction between a surface, which includes a line (generatrix of the cylindrical surface 43) intersecting the non-arc axis (or arc center axis) of the cylindrical surface 43 and the cylindrical surface and is parallel with the plane B, and a surface, which includes a line (generatrix of the cylindrical surface 44) intersecting the non-arc axis (or arc center axis) of the cylindrical surface 44 and the cylindrical surface and is parallel with the plane B.

The “tilt decentering of each plane” means a difference between an angle, which is formed by a surface in the generatrix direction including the line intersecting the non-arc axis (or arc center axis) of the cylindrical surface 43 (generatrix of the cylindrical surface 43), and an angle, which is formed by a surface in the generatrix direction including the line intersecting the non-arc axis (or arc center axis) of the cylindrical surface 44 and the cylindrical surface (generatrix of the cylindrical surface 34) and the plane B.

When the plane which is obtained by connecting the generatrix of the cylindrical surface 43 and the generatrix of the cylindrical surface 44 is called as “plane A”, the plane B, the plane C and the plane A are approximately parallel in the beam shaping element obtained in the above manner.

When the beam shaping element of the present invention is assembled together with LD, the plane B or the plane C is used as a reference. As a result, when a jig for mounting the beam shaping element and LD obtains accuracy in the parallel decentering direction, the parallel decentering adjustment is not necessary. The tilt decentering adjustment is occasionally necessary. This is because the tilt decentering tolerance of the block between the beam shaping element and LD is generally more strict than the tilt decentering tolerance of each plane of the beam shaping element. The “tilt decentering tolerance of the block between the beam shaping element and LD” means a tilt decentering amount which is allowed when the beam shaping element and LD are assembled. More specifically, this tolerance is defined by an allowable value of the tilt decentering between the plane which is vertical to the plane A and includes the generatrix of the cylindrical surface 33 or 34 and an optical axis of the emitted light from LD. The tilt decentering tolerance of the block is generally about 5 min. or less, and when an allowable width is large, it is about 20 min. or less. Further, since any one of the plane B and the plane C may be used for the parallel decentering adjustment, from the viewpoint of the parallel decentering adjustment, the plane C is not indispensably a plane as long as the plane B can be used for the parallel decentering adjustment, and thus the plane C may have an arc-like curved shape, for example.

The method of the present invention can manufacture the element, in which a difference between the distance between the plane A and plane B and the distance between the plane A and the plane C is not more than the parallel decentering tolerance of the block between LD and the beam shaping element. Even when such a beam shaping element is rotated 180° in an optical recording apparatus, for example, the element can be placed similarly to the case before the rotation. It is not, therefore, necessary to provide a maker indicating the element placing direction for assembly of the element, and thus the element can be assembled in any directions.

The “parallel decentering tolerance of the block” means the parallel decentering amount which is allowed when the beam shaping element and LD are assembled, and more specifically, it is defined by an allowable value of the parallel decentering in the directrix direction between the plane A and the optical axis of the emitted light from LD. The parallel decentering tolerance of the block is generally not more than about 10 μm, and when the allowable width is large, it is not more than about 50 μm.

In the beam shaping element manufactured by the method, at least the side surface (plane B or/and the plane C) in the directrix direction can be used directly as the side surface the transfer surface of the side surface forming member, and thus the step of the grinding or cutting steps can be reduced.

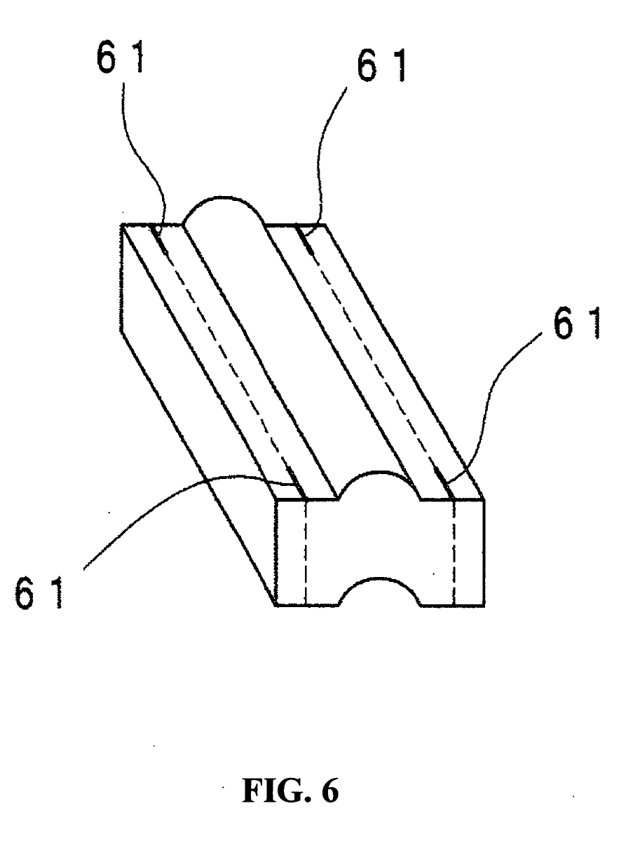

In the case where the side surface in the directrix direction is formed by a post-process such as cutting, grinding or the like, as shown in FIG. 6, it is convenient that a marker for cutting, such as a line, a point or a dotted line is transferred to the molded article. This marker is used for enabling the process so that the distance between the generatrix position and the side surface in the directrix direction of the beam shaping element has a predetermined value similarly to the case where the side surface in the directrix direction is used as the transfer surface. When such a marker is used, even if the distance between the generatrix position and the side surface in the directrix direction is not specified, the width of the beam shaping element in the directrix direction can be within a constant range (in general, tolerance: ±10 μm).

The marker is provided to the mold and is transferred by molding. The marker may be suitably provided according to objects, and it may be provided to only one of both the surfaces.

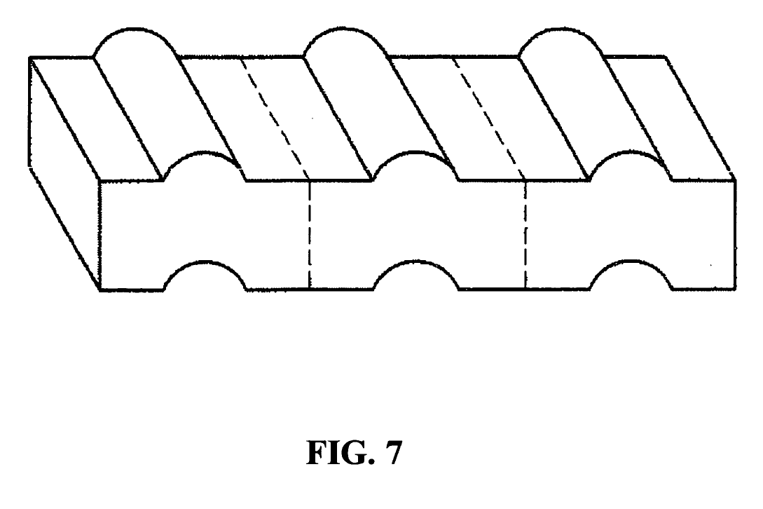

FIG. 7 is a schematic perspective view illustrating the beam shaping element molded article (three pieces are obtained: before cutting) in which a plurality (three) of the beam shaping elements whose both surfaces are cylindrical surfaces are arranged in the directrix direction. In this case, the mold, which is processed so that the distance between the generatrices of the upper and lower molds corresponding to formation of both the cylindrical surface of the respective beam shaping elements and the reference surfaces of the upper and lower molds obtains a specified value, or the mold where the marker explained in FIG. 6 can be transferred is used. As the other technical matters, the matters, which are explained above referring to the plural beam shaping elements arranged in the generatrix direction whose both surfaces are cylindrical surfaces, can be applied. In the case where the molded article where the plural (three) beam shaping elements are arranged in the directrix direction is used, it is preferable that the side surface forming member is pressed against at least one of the upper and lower mold reference surfaces, and further the side surface forming member is pressed against at least one of the side surfaces of the upper and lower molds in the generatrix direction.

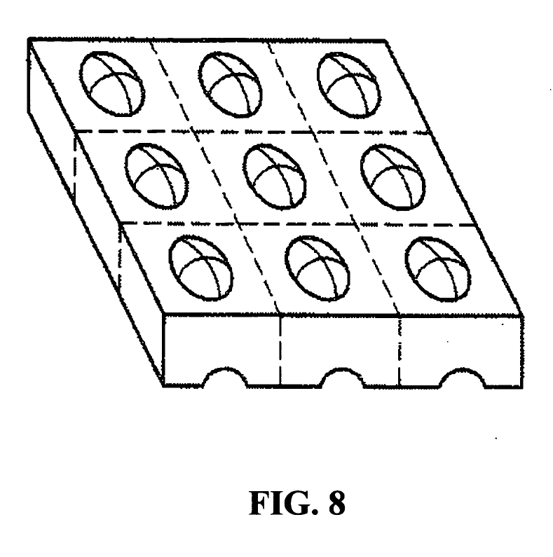

FIG. 8 is a schematic perspective view illustrating a beam shaping element molded article (nine pieces are obtained: before cutting) where a plurality of the beam shaping elements whose one surface is the cylindrical surface and other surface is the anamorphic surface are arranged in the generatrix and directrix directions. FIG. 8 illustrating the beam shaping element whose one surface is the anamorphic surface, but the present invention can be applied similarly to the beam shaping element whose both surfaces are cylindrical surfaces.

Also in this case, the mold, which is processed so that the distance between the generatrices of the upper and lower molds corresponding to the formation of the cylindrical surface and the anamorphic surface of the respective beam shaping elements and the reference surfaces of the upper and lower molds obtains a specified value, or the mold, which can transfer the marker explained in FIG. 6, is used. As the other technical matters, the technical matters, which are explained above referring to the beam shaping elements whose both surfaces are cylindrical surfaces arranged in the generatrix direction, can be used. In the case where the molded article where a plurality (three pieces) of the beam shaping elements are arranged in the directrix direction is used, it is preferable that the side surface forming member is pressed against at least one of the reference surfaces of the upper and lower molds, and further the side surface forming member is pressed against at least one of the side surfaces of the upper and lower molds in the generatrix direction.

In the case where the molded article where the plural beam shaping elements are arranged in both the directrix and generatrix directions is obtained and then the respective beam shaping elements are manufactured, it is preferable that the marker for cutting explained with reference to FIG. 6 is transferred to the molded article.

This marker is used for the process so that the distance between the generatrix position and the side surface in the directrix direction of the beam shaping element obtains a specified value. Also in the case where the distance between the generatrix position and the side surface in the directrix direction is not specified, the widths of the beam shaping element in the directrix and generatrix directions can be within a constant range (in general, tolerance: ±10 μm).

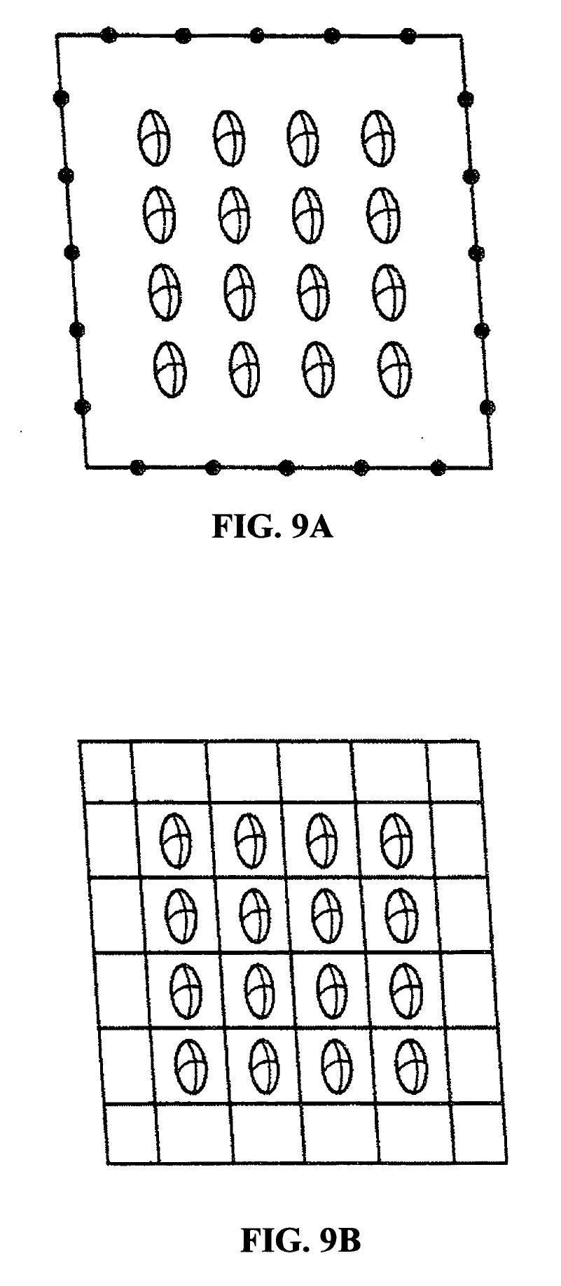

As shown in FIG. 9A, the marker may be a dot group for obtaining a straight line desired to be processed by connecting points, or a straight line representing all or part of the processing line as shown in FIG. 9B. Only one marker line may be provided in the generatrix direction, and the remaining cutting pitches may be substituted for pitches obtained from the mold processed result.

“The marker” is composed of a line or a dot group, and is formed parallel with the directrix direction of the beam shaping element. It is desirable that the marker in the directrix direction is provided to the element optical surface so as to be a reference of a measurement position at the time of evaluating the transmission wave surface. As a result, when the accuracy of the transmission wave surface varies in the position of the generatrix direction of the element and performance is defective in some area, the performance of the element is previously measured based on the mark in the directrix direction, and the marker in the directrix direction is used as a reference for determining the cutting position. As a result, only a portion with good performance can be cut out.

It is desirable that the marker is provided to a position which is 0.5 mm to 5 mm from the end of the element so that defective appearance is prevented. When the marker is in the position which is not more than 0.5 mm from the end, the marker is insufficiently transferred, and thus the marker does not function properly. When the marker is in the position which is not less than 5 mm from the end, the marker is provided to a non-defective element after the cutting, thereby causing defective appearance.

The typical method of manufacturing beam shaping element and the beam shaping element which is obtained by the method according to the present invention are provided as follows. The other various modes are carried out by referring to the gist and the object of the present invention and the description in the specification, and these modes are included in the present invention.

1. A method of manufacturing a beam shaping element, the beams shaping element having a square outer shape and having both cylindrical surfaces or a cylindrical surface as one surface and an anamorphic surface as the other surface, the method comprising the steps of:

manufacturing a molded article where a plurality of beams shaping elements′are arranged using one set of molds for forming the respective surfaces at one-time molding: and

cutting the molded article into respective beam shaping elements.

2. The method of manufacturing a beam shaping element according to claim 1, wherein the plural beam shaping elements are arranged in a generatrix direction.

3. The method of manufacturing a beam shaping element according to claim 2, wherein the molding is carried out with restrictions in both a directrix direction and the generatrix direction of the beam shaping element.

4. The method of manufacturing a beam shaping element according to claim 2, wherein the molding is carried out with restriction only in the directrix direction of the beam shaping element.

5. The method of manufacturing a beam shaping element according to any one of claims 2 to 4, wherein the molding is carried out by a reheat method, and a thickness of a glass preform to be used in the reheat method is not less than 1.05 times as large as a target center thickness of the beam shaping element.

6. A beam shaping element which is manufactured by the method of manufacturing a beam shaping element according to any one of claims 2 to 5.

7. The beam shaping element obtained by the manufacturing method according to claim 3, wherein a side surface of the beam shaping element in a directrix direction is a transfer surface formed at the time of molding.

8. The beam shaping element obtained by the manufacturing method according to claim 3, wherein a side surface of the beam shaping element in a directrix direction is a processing surface formed by a post-process.

9. The beam shaping element obtained by the manufacturing method according to claim 4, wherein a side surface of the beam shaping element in a directrix direction is a processing surface formed by a post-process.

10. The method of manufacturing a beam shaping element according to claim 1, wherein a plurality of beam shaping elements are arranged in a directrix direction.

11. The method of manufacturing a beam shaping element according to claim 10, wherein the molding is carried out with restrictions in both the directrix and generatrix directions of the beam shaping element.

12. The method of manufacturing a beam shaping element according to claim 10, wherein the molding is carried out with restriction only in the directrix direction of the beam shaping element.

13. The method of manufacturing a beam shaping element according to any one of claims 10 to 12, wherein the molding is carried out by a reheat method, and a thickness of a glass preform to be used in the reheat method is 1.05 or more times as large as a desired center thickness of the beam shaping element.

14. A beam shaping element which is manufactured by the method of manufacturing a bean shaping element according to any one of claims 10 to 13.

15. The beam shaping element manufactured by the manufacturing method according to claim 11, wherein a side surface of the beam shaping element in the generatrix direction is a transfer surface formed at the time of molding.

16. The beam shaping element manufactured by the manufacturing method according to claim 11, wherein a side surface of the beam shaping element in the generatrix direction is a processing surface formed by a post-process.

17. The beam shaping element manufactured by the manufacturing method according to claim 12, wherein a side surface of the beam shaping element in the generatrix direction is a processing surface formed by a post-process.

18. The method of manufacturing a beam shaping element according to claim 1, wherein a plurality of beam shaping elements are arranged in directrix and generatrix directions

19. The method of manufacturing a beam shaping element according to claim 18, wherein the molding is carried out with restriction in both the directrix and generatrix directions of the beam shaping element.

20. The method of manufacturing a beam shaping element according to claim 18, wherein the molding is carried out with restriction only in the directrix direction.

21. The method of manufacturing a beam shaping element according to any one of claims 18 to 20, wherein the molding is carried out by a reheat method, and a thickness of a glass preform to be used in the preheat method is 1.05 or more times as large as a target center thickness of the beam shaping element.

22. A beam shaping element which is manufactured by the method of manufacturing a beam shaping element according to any one of claims 18 to 21.

23. The beam shaping element manufactured by the method of manufacturing a beam shaping element according to claim 19, wherein side surfaces of the beam shaping element in the directrix and generatrix directions are processing surfaces formed by a post-process.

24. The beam shaping element manufactured by the manufacturing method according to claim 19, wherein the beam shaping element is one which is positioned on an outer periphery of a molded article where a plurality of beam shaping elements are arranged, and a transfer surface formed at the time of molding is provided to at least one of side surfaces of the element.

25. The beam shaping element manufactured by the manufacturing method according to claim 24, wherein the side surfaces of the beam shaping element in the directrix and generatrix directions are processing surfaces formed by a post-process.

26. The method of manufacturing a beam shaping element according to any one of claims 1 to 5, 10 to 13 and 18 to 21, wherein at the time of the molding, a marker for cutting the molded article where a plurality of beam shaping elements are arranged is transferred from the mold to the molded article.

27. The method of manufacturing a beam shaping element according to claim 26, wherein the marker is a line or a dot group parallel with the generatrix direction.

28. The method of manufacturing a beam shaping element according to claim 26, wherein the marker is a line or a dot group parallel with the directrix direction.

29. The method of manufacturing a beam shaping element according to claim 26, wherein the marker is a line or a dot group parallel with the generatrix and directrix directions.

The above explanation refers to the case where the optical element is the beam shaping element, but the present invention can be applied also to optical elements other than the beam shaping elements.

Although the present invention has been fully described by way of examples with reference to the accompanying drawings, it is to be noted that various changes and modifications will be apparent to those skilled in the art. Therefore, unless such changes and modification depart from the scope of the present invention, they should be construed as being included therein.

What is claimed is:

1. A method of manufacturing an optical element having a square outer shape, said method comprising the steps of:
manufacturing a molded article where a plurality of optical elements are arranged using one set of molds for forming the respective surfaces at one-time molding: and
cutting the molded article into respective optical elements.

2. A method according to claim 1, wherein the molding is carried out with restrictions in both a directrix direction and the generatrix direction of the beam shaping element.

3. A method according to claim 1, wherein the molding is carried out with restriction only in the directrix direction of the beam shaping element.

4. A method according to claim 1, wherein the plurality of optical elements are arranged in a generatrix direction.

5. A method according to claim 4, wherein a side surface of the optical element in a directrix direction is a transfer surface formed at the time of molding.

6. A method according to claim 4, wherein a side surface of the optical element in a directrix direction is a processing surface formed by a post-process.

7. A method according to claim 1, wherein the plurality of optical elements are arranged in a directrix direction.

8. A method according to claim 7, wherein a side surface of the optical element in a generatrix direction is a transfer surface formed at the time of molding.

9. A method according to claim 7, wherein a side surface of the optical element in a generatrix direction is a processing surface formed by a post-process.

10. A method according to claim 1, wherein the plurality of optical elements are arranged in directrix and generatrix directions.

11. A method according to claim 10, wherein a side surface of the optical element in generatrix and directrix directions is a transfer surface formed at the time of molding.

12. A method according to claim 10, wherein a side surface of the optical element in generatrix and directrix directions is a processing surface formed by a post-process.

13. A method according to claim 1, wherein a marker for cutting the molded article where the plurality of optical elements are arranged is transferred from the mold to the molded article at the time of the molding.

14. A method according to claim 1, wherein the molded article is obtained by reheating a glass preform.

15. A method according to claim 14, wherein a thickness of the glass preform is 1.05 or more times as large as a center thickness of the optical element.

16. A method according to claim 1, wherein both sides of the optical element include cylindrical surfaces.

17. A method according to claim 1, wherein one side of the optical element includes a cylindrical surface and another side includes an anamorphic surface.

18. A method of manufacturing an optical element, the optical element having a square outer shape and having both cylindrical surfaces or a cylindrical surface as one surface and an anamorphic surface as the other surface, the method comprising the steps of:
manufacturing a molded article where a plurality of optical elements are arranged using one set of molds for forming the respective surfaces at one-time molding; and
cutting the molded article into respective optical elements.

19. A method of manufacturing a beam shaping element for shaping a section of a beam emitted from a laser diode, the beam shaping element having a square outer shape and having both cylindrical surfaces or a cylindrical surface as one surface and an anamorphic surface as the other surface, the method comprising the steps of:
manufacturing a molded article where a plurality of beam shaping elements are arranged using one set of molds for forming the respective surfaces at one-time molding; and
cutting the molded article into respective beam shaping elements.
